(19) United States
(12) Patent Application Publication
(10) Pub. No.: US 2006/0033495 A1
(43) Pub. Date: Feb. 16, 2006

(54) Magnetic resonance imaging device

(75) Inventors: Takashi Yamamizu, Chiba (JP); Shigeru Sato, Ibaraki (JP); Yoshiyuki Miyamoo, Chiba (JP); Teruaki Itabashi, Chiba (JP); Yoshiaki Amano, Tokyo (JP); Mitsuru Onuma, Tokyo (JP); Masakatsu Iwasaki, Tokyo (JP); Yoshimi Kasai, Tokyo (JP)

Correspondence Address: COOPER & DUNHAM, LLP, 1185 AVENUE OF THE AMERICAS, NEW YORK, NY, 10036, US

(73) Assignee: Hitachi Medical Corporation, Tokyo (JP)

(21) Appl. No.: 10/519,891

(22) PCT Filed: Jun. 30, 2003
(86) PCT No.: PCT/JP03/08282

§ 371 Date: Dec. 29, 2004

(30) Foreign Application Priority Data
Jul. 1, 2002 (JP) 2002-191986

(51) Int. Cl. G01V 3/00

(52) U.S. Cl. 324/318

(57) ABSTRACT

A magnetic resonance imaging apparatus includes an upper magnet and a lower magnet arranged oppositely and concentrically, a pair of columns installed over the outer part of the upper magnet and the lower magnet in a vertical direction, and a bed having a top plate on which an object to be examined is placed and which is inserted into a measurement space between the upper magnet and the lower magnet, wherein the pair of columns are arranged oppositely with respect to a central axis of the upper magnet and the lower magnet, a cross sectional area of one of the pair of columns is made smaller than that of the other, and a direction of bed insertion is inclined to the side of the column with small cross sectional area with respect to a line perpendicular to a line connecting the centers of the pair of columns and passing through the center of the pair of magnets.

### TECHNICAL FIELD

The present invention relates to a magnetic resonance imaging apparatus of vertical magnetic field system having a pair of magnets oppositely arranged in a vertical direction, more particularly to a structure of column and bed with which the access to an object to be examined becomes easy.

### BACKGROUND OF THE INVENTION

A magnetic resonance imaging (hereinafter referred to as “MRI”) apparatus of vertical magnetic field type includes a gantry which has a pair of magnets for forming a static magnetic field oppositely arranged in a vertical (up-down) direction with respect to a measurement space to which an object to be examined is inserted and columns installed over the upper and lower magnets and holding the upper magnet, and a bed device (hereinafter referred to as “bed”) having a top plate on which the object is placed and which is inserted into the measurement space between the magnets and a bed base for supporting the top plate.

This kind of MRI apparatus of vertical magnetic field type is practically used in so-called interventional MR for picturing the object (i.e. patient) and performing invasive treatment like surgery while monitoring the image. In the interventional MR, it is needed easy access to the object for an operator (i.e. doctor), particularly an access to the object from both of the sides of the object's body axis and the side to which the bed is inserted, i.e. the side of object's feet when the object is inserted from the object's head. Particularly in the interventional MR, because a plurality of operators, such as a doctor and an assistant have access to the object from various directions, it is important that the operators have an access to the object from both sides of object.

Because the MR imaging is performed mainly at the center of the magnet where the static magnetic field is the most stable, the accessibility to the imaging portion of the object positioned at the center of the magnet is especially important. Moreover, to reduce the burden on the object, it is also necessary that the object can feel openness, in other words the gantry has openness.

Meanwhile, in the MRI apparatus of vertical magnetic field type, it is desirable that the upper magnet is held by two columns arranged symmetrically to the center of the magnet in the outer part of the upper and lower magnets in order to maintain structural strength of the apparatus. Japanese Unexamined Patent Publication No. 2001-198099 proposes an example of the MRI apparatus in which the accessibility and openness are improved in the above described column structure. In this MRI apparatus, a direction of a line connecting the columns intersects the longitudinal direction of the bed at an angle of 45 degrees. With this construction of the column and bed, it becomes easy access to the object from the sides of the body axis.

However, the column shifted to the side where the bed is inserted becomes an obstacle to the access from the side of the object's feet when the object is inserted from the head. Accordingly, it is still difficult that the operators have an access to the object from various directions.

### SUMMARY OF THE INVENTION

An object of the present invention is to make easy the access to the object to be examined from various directions in the MRI apparatus of vertical magnetic field type in which two columns are arranged symmetrically to the center of the magnet.

To achieve the above object, the magnetic resonance imaging apparatus according to the present invention is constructed as follows.

The magnetic resonance imaging apparatus includes a gantry having a pair of upper magnet and lower magnet arranged concentrically and oppositely in a vertical direction with respect to a measurement space to which an object to be examined is inserted and pair of columns for supporting the above magnet which is installed over the outer part of the upper and lower magnets in the vertical direction, and a bed having a top plate inserted into the measurement space on which the object is placed, wherein the pair of columns are arranged oppositely with respect to the central axis of the upper and lower magnets, and a cross sectional area of one of the pair of columns is made smaller than that of the other one.

With this structure, structural strength of the MRI apparatus of vertical magnetic field type is kept, while the openness on the side of the column with small cross sectional area is improved. Accordingly, it becomes easy to access the object from that direction.

According to one desirable embodiment, the width of the column with the small cross sectional area in a direction perpendicular to the line connecting the centers of the pair of columns is made ½ or smaller of that of the other column.

With this structure, the column with small cross sectional area becomes thin, and so the openness is further improved. Accordingly, the access to the object from this direction becomes further easier.

Further, according to one desirable embodiment, either of both of the pair of columns has a shape curved toward outside.

With this structure, the communication and handover of tools among operators respectively besides the column becomes easy.

Further, according to one desirable embodiment, the bed is disposed so that the top plate is inserted toward the center of the pair of magnets from the side of the column with small cross sectional area with respect to a line perpendicular to the line connecting the centers of the pair of columns and passing through the center of the pair of magnets.

With this structure, a free space on the side of the column with large cross sectional area is sufficiently increased, whereby the access to the object from this direction becomes easy. Meanwhile, the access to the object from the opposite direction also becomes easy because the cross sectional area of the column on this side is small. That is, the access to the object from both sides becomes easy. Therefore, it is possible to access the object particularly from both sides of the object's feet when the object is inserted from the head.

Further, according to one desirable embodiment, the angle between the direction of the line perpendicular to the line connecting the center of the pair of columns and passing through the center of the pair of magnets and the direction in which the top plate is inserted is in the range from 15 to 45 degrees, preferably from 25 degrees to 35 degrees.

With this structure, a desirable balance of the accessibility to the object from each column is obtainable.

Further, according to one desirable embodiment, the bed is disposed so that the top plate is inserted from a position in the vicinity of the column with large cross sectional area toward the center of the pair of magnets.

With this structure, when the object is accessed from both sides of the object, the accessible area to the object becomes maximum because the operators are positioned respectively beside the column with small cross sectional area. Accordingly, it is possible to easily access the object from any direction.

Further, according to one desirable embodiment, the apparatus includes a bed fixing section for determining the disposing position of the bed, which is movable along the outer part of the gantry and which is connected with a connecting section of the bed. The bed fixing section is disposed so that the top plate is inserted toward the center of the pair of magnets, and the bed is fixed by connecting the bed fixing section with the connecting section of the bed.

With this structure, by pre-adjusting the disposing position of the bed fixing section, the connection angle of the bed can be easily adjusted.

Further, according to one desirable embodiment, the column with smaller cross sectional area has a substantially rectangular cross section, and the longitudinal direction of this cross section corresponds to the diameter direction of the magnet.

With this structure, the strength of the column is kept, while the accessibility to the object from the side of this column can be improved. Furthermore, because the column with small cross sectional area seems to be thin from the object, the oppressiveness to the object can be reduced.

Further, according to one desirable embodiment, the side surface of the column with large cross sectional area facing the magnet center is tapered shape with its top pursed toward an end.

With this structure, it is possible to make the object hardly feel the visual oppressiveness.

### BRIEF DESCRIPTION OF THE DRAWINGS

FIG. 1 is a perspective view showing a structure of upper and lower magnets and a gantry of an MRI apparatus according to a first embodiment of the present invention.

FIG. 2 is a plan view of the MRI apparatus of FIG. 1, where the top plate is inserted from the side of the column with small cross sectional area.

FIG. 3 is an elevational view of the MRI apparatus of FIG. 1 seen from the side perpendicular to the longitudinal direction of the bed.

FIG. 4 is a plan view showing the state of the MRI apparatus of FIG. 1 in use.

FIG. 5 is a plan view of an MRI apparatus according to a second embodiment of the present invention, where the structure according to the first embodiment is reversed with respect to a central axis of the longitudinal direction of bed 9.

FIG. 6 is a plan view of the MRI apparatus according to a third embodiment of the present invention, where the top plate is inserted from the side of the column with large cross sectional area.

FIG. 7 is a plan view of the MRI apparatus according to a fourth embodiment of the present invention, where the column has a shape curved toward outside.

FIG. 8 is a diagram showing a simulation result concerning an inserting angle of the top plate, wherein (a) is a diagram showing the portion to be simulated and (b) is a graph presenting the simulation result.

### BEST MODE FOR CARRYING OUT THE INVENTION

Hereinafter, the first embodiment of the MRI apparatus according to the present invention will be described.

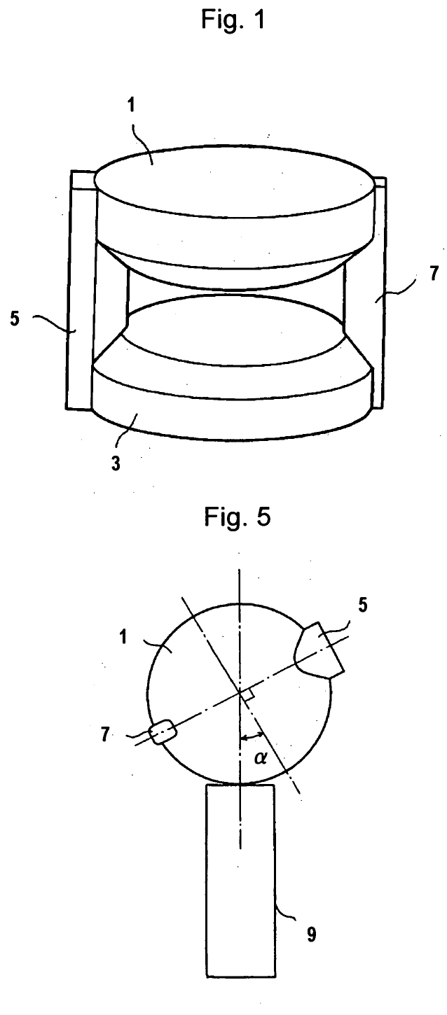

FIG. 1 is a perspective view showing the structure of the upper and lower magnets and the gantry of the MRI apparatus according to this embodiment. FIG. 2 is a plan view of the MRI apparatus using the gantry of FIG. 1. As shown in FIG. 1, the gantry of the MRI apparatus according to this embodiment is constructed with disk-shaped upper magnet 1 and lower magnet 3 which are separated and oppositely arranged, and column 5 and column 7 connecting upper magnet 1 with lower magnet 3 and holding upper magnet 1. This gantry includes bed 9 having top plate 11 having a substantially rectangular plain shape inserted into a measurement space between the upper and lower magnets along its longitudinal direction, and bed base 10 for holding this top plate 11 as shown in FIG. 2.

As shown in FIG. 1, upper magnet 1 has an upper part with a cylindrical side surface and a lower part formed into a shape like conic trapezoid continuously tapered downward from the upper part. The lower surface of the conic trapezoidal part, i.e. the surface opposing to lower magnet 3 is formed into a circular plane. An intersecting portion of this plane and the lower side of the tapering surface is chamfered to have a round surface. Lower magnet 3 has a shape symmetrical to upper magnet 1. The outer diameter of upper magnet 1 and lower magnet 3 is, e.g. 2200 mm.

As shown in FIG. 2, column 5 and column 7 are arranged opposite with respect to the central axis of the upper and lower magnets in the outer part of upper magnet 1 and lower magnet 3. That is, the centers of column 5 and column 7 are located at positions on an outer circumference of upper magnet 1 and lower magnet 3 and separated by 180 degrees. Further, column 5 and column 7 have a cross sectional shape axisymmetrical to a line connecting the centers of their cross section. A cross sectional area of column 5 is larger than that of column 7. The cross section of column 5 is shaped so that one long side of the rectangle is projected, and the top of the projection has a round surface and faces the center of the magnet.

On the other hand, column 7 has a substantially rectangular cross section and is disposed so that its longitudinal direction is oriented toward column 5 (i.e. in a diameter direction of each magnet). Four corners thereof is chamfered to have a small round'surface. Column 7 is disposed so that the central axis in the longitudinal direction of its cross section corresponds with the diameter direction of each magnet. Those column 5 and column 7 have an identical cross section from the upper part of upper magnet 1 to the lower part of lower magnet 3 and extend in a vertical direction. Meanwhile, a width of column 5 in a direction perpendicular to the line connecting the centers of column 5 and column 7 is, e.g. 680 mm, and that of column 7 is, e.g. 265 mm.

Next, bed 9 is disposed so that the central axis in the longitudinal direction of bed 9 intersects at an angle of α=30 degrees with the line passing through the magnet center and connecting the centers of columns 5 and 7, and column 7 with the small cross sectional area is disposed near the position where top plate 11 is inserted. That is, as shown in FIG. 2, bed 9 is disposed so that column 7 is positioned on the right front side and column 5 is positioned on the left back side when bed 9 is seen from the side where top plate 11 is inserted.

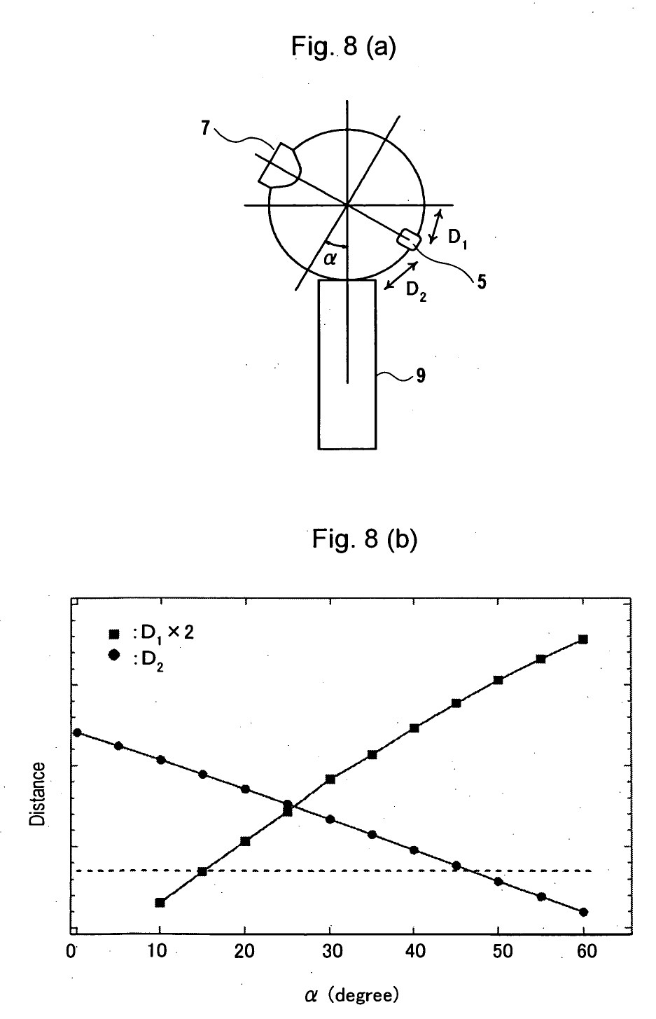

Here, the result of investigation of studying a desirable range of a will be described. FIG. 8 is the simulation result concerning an accessible circumferential length of the outer part of the magnet with respect to α. FIG. 8(b) shows the variation of D₁x2 and D₂ shown in FIG. 8(a) in the case of changing a. Here, referential marks are given as follows:
▪: D₁x2 (Access to patient rightly from his/her sides)
●: D₂
   D₁ is doubled because the access to the object from just his/her sides is necessary at least from one direction, and so it is desirable that the double of D₁ is larger than the width of operator in consideration of the space where the operator stands on the just object's side. The dotted line in FIG. 8(b) represents the minimum space where a person can stand, and it is desirable that D₁x2 and D₂ are larger than it. It is revealed from FIG. 8(b) that the range for keeping D₁ in preference to D₂ is α=15 to 45 degrees, preferably 25 to 35 degrees.

Next, an experimentally preferable range of the width of column 7 with small cross sectional area is at most ½ or smaller of the width of column 5 with large cross sectional area from the point of view that the object can feel apparent openness based on a difference between the widths of both columns. Of course, the width of column 7 with small cross sectional area is better to be as thinner as possible.

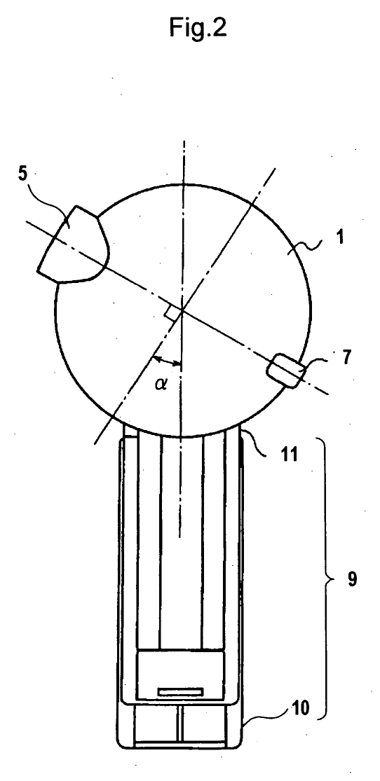

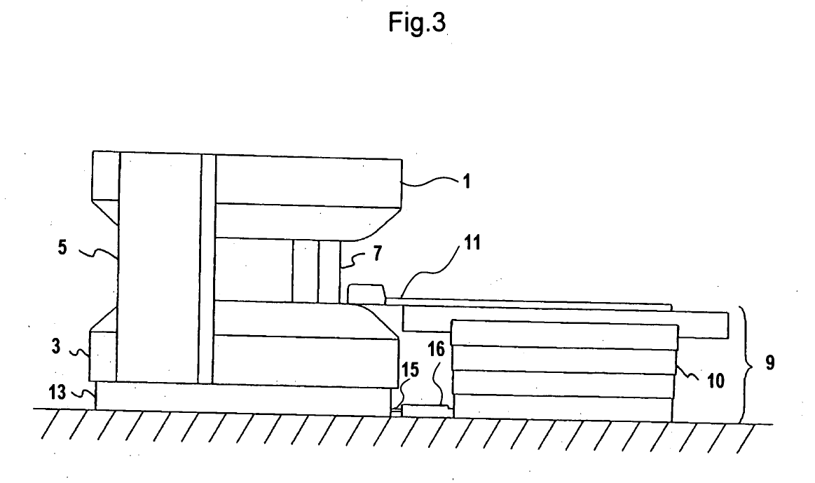

FIG. 3 is an elevational view of the MRI apparatus of FIG. 2 seen from the direction perpendicular to the longitudinal direction of bed 9. Bed 9 includes bed base 10 and top plate 11. Bed base 10 has a mechanism of moving top plate 11 up and down, horizontally, and transversely, and top plate 11 positioned in the upper part of bed base 10 can be inserted from an arbitrary position. Further, four legs, for instance, are provided to a portion of the lower part of lower magnet 3 covered by cover 13, which support the upper and lower magnets and the pair of columns. The lower part of lower magnet 3 is provided with bed fixing attachment 15 projecting from the sidewall of cover 13 and connected with bed connecting section 16 of the lower part of bed base 10. Bed fixing attachment 15 is detachable to bed connecting section 16 and holds bed 9 in the positional relationship described above with reference to FIG. 2 when they are connected. Necessary electrical wirings are made in this connection mechanism section.

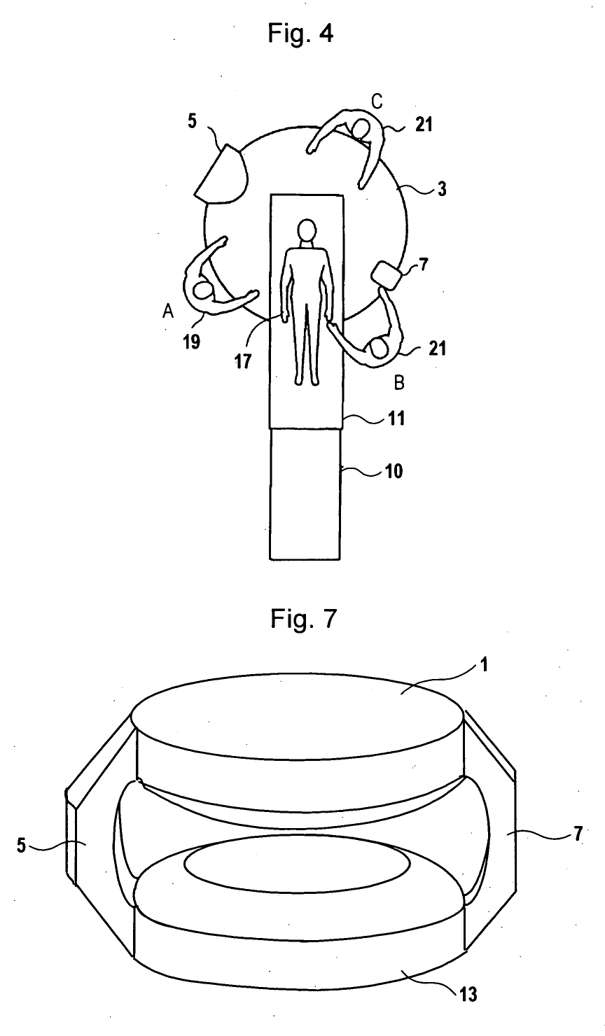

Next, the operation of the MRI apparatus according to this embodiment will be described. FIG. 4 is a diagram showing the MRI apparatus in use according to this embodiment. As shown in FIG. 4, object 17 to be examined is laid on top plate 11. Top plate 11 is inserted into the measurement space between upper magnet 1 and lower magnet 3 along the central axis in its longitudinal direction. The examining portion of the object is moved toward the substantial center of the upper and lower magnets. Meanwhile, in FIG. 4 the examining portion is the object's head. An operator like a doctor conducts operation of the MRI apparatus and necessary treatment to object 17 from any position of area A between column 5 and top plate 11, area B between top plate 11 and column 7, or area C between column 7 and column 5. Operator 19 being a doctor often stands in area A, where he/she can sequentially observe the state of object 17 before and after inserting the top plate between the magnets and has easy access to object 17. An assistant of the operator also can conduct operation of the apparatus and treatment to object 17 from area B or C. Further, a plurality of doctors 19 and assistants 21 can have an access to object. 17 from one, two or more areas among areas A, B, and C.

According to this embodiment, because top plate 11 is inserted at an angle of 30 degrees to the line perpendicular to the line connecting the centers of columns, the columns are not positioned at just sides of the body axis. Accordingly, the access to the object from this area is easy and the object can feel openness. Further, the cross sectional area of column 7 is small, and the column is shifted to the side where top plate 11 is inserted, i.e. to the side of the object's feet in the case that the object is inserted from the head. Therefore, this column 7 hardly becomes an obstacle to the access to the object.

Meanwhile, since the column on the side of the object's feet which can be easily seen from the object is thin, the openness is improved. Particularly, different from a technique described in Japanese Unexamined Patent Publication No. 2001-198099 in which the bed is inserted at an angle of 45 degrees with respect to the line perpendicular to the line connecting the centers of columns and in which two columns have an identical cross sectional shape, operationality in area B of FIG. 4, i.e. a space between the column on the near side in the inserting direction of bed 11 and top plate 11 is greatly improved. This arrangement is particularly suitable for operation of the interventional MR.

The arrangement of each component according to the above described embodiment may be reversed with respect to the central axis of bed 9 in the longitudinal direction. FIG. 5 is a plan view of the MRI apparatus according to the second embodiment of the present invention using this structure. In the figure, the same component as in the first embodiment is given an identical reference. With this structure, the similar effect to that in the above described first embodiment is obtainable.

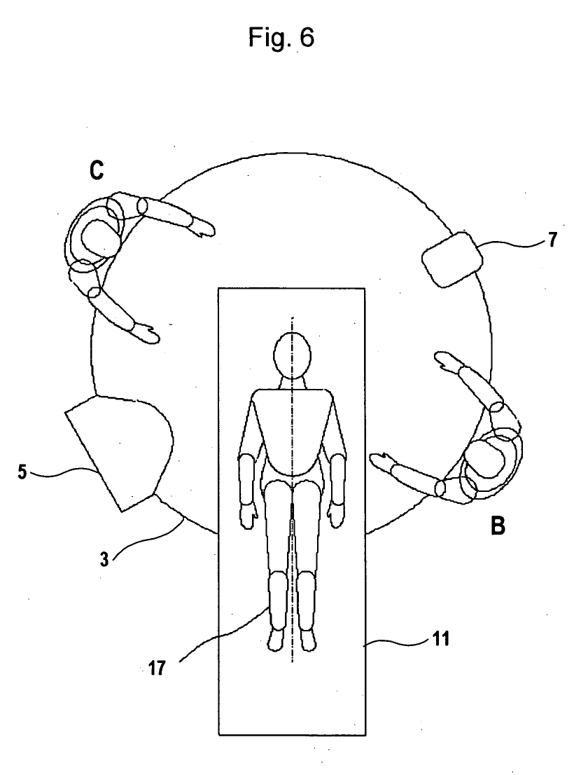

The above is the description of the case that the top plate is inserted from the side of column 7 with small cross sectional area. However, as a third embodiment concerning the top plate insertion particularly for improving the accessibility from both sides of the object, by inserting top plate 11 from the side of column 5 with large cross sectional area (i.e. from a position where α=substantially −90 degrees) as shown in FIG. 6, the accessibility of two operators B and C respectively on both sides of column 7 with small cross sectional area becomes best. This improvement of accessibility owes to the fact that the cross sectional area of column 7 between them is small. The second embodiment of FIG. 5 also has the same feature.

Further, according to the above embodiments, the pair of columns respectively has an identical cross section which extends vertically. However, the present invention is not limited thereto and the both columns may have a shape, e.g. curved toward outside (fourth embodiment) as shown in FIG. 7. Meanwhile, either of the columns may be curved. By thus shaping the columns, communication and handover of tools among operators on the both sides of the column become easy.

1. A magnetic resonance imaging apparatus comprising:
a gantry including a pair of upper magnet and lower magnet arranged oppositely and concentrically in a vertical direction, sandwiching a measurement space to which an object to be examined is inserted and a pair of columns for supporting the upper magnet installed over the outer parts of the upper magnet and the lower magnet in the vertical direction; and
a bed on which the object is placed, including a top plate inserted to the measurement space, wherein
the pair of columns is oppositely arranged with respect to a central axis of the upper magnet and the lower magnet, and
a cross sectional area of one column of the pair of columns is made smaller than that of the other.

2. A magnetic resonance imaging apparatus according to claim 1, wherein a width of the column with small cross sectional area in a direction perpendicular to a line connecting centers of the pair of columns is ½ or smaller of that of the other column in the identical direction.

3. A magnetic resonance imaging apparatus according to claim 1 or 2, wherein either or both of the pair of columns has a shape curved toward outside.

4. A magnetic resonance imaging apparatus according to any of claims 1 to 3, wherein the bed is disposed so that the top plate is inserted toward the center of the pair of magnets from the side of the column with small cross sectional area with respect to a line perpendicular to a line connecting the centers of the pair of columns and passing through the center of the pair of magnets.

5. A magnetic resonance imaging apparatus according to claim 4, wherein the direction of the line perpendicular to the line connecting the centers of the pair of columns and passing through the center of the pair of magnets intersects with a direction of the top plate insertion at an angle of 15 to 45 degrees, preferably 25 to 35 degrees.

6. A magnetic resonance imaging apparatus according to any of claims 1 to 3, wherein the bed is disposed so that the top plate is inserted from a position in the vicinity of the column with large cross sectional area toward the center of the pair of magnets.

7. A magnetic resonance imaging apparatus according to any of claims 4 to 6 further comprising a bed fixing section for determining the position of disposing the bed movable along the periphery of the gantry and connected to a connecting section of the bed, wherein the bed fixing section is disposed so that the top plate is inserted from the predetermined position toward the center of the pair of magnets, and the bed is fixed by connecting the connecting section of the bed with the bed fixing section.

8. A magnetic resonance imaging apparatus according to any of claims 1 to 6, wherein the column with small cross sectional area has a substantially rectangular cross section, and its longitudinal direction corresponds to the diameter direction of the magnet.

9. A magnetic resonance imaging apparatus according to any of claims 1 to 7, wherein the side surface of the column with large cross sectional area facing the magnet center is tapered with its top pursed
